(19) United States
(12) Patent Application Publication
(10) Pub. No.: US 2019/0293217 A1
(43) Pub. Date: Sep. 26, 2019

(54) WATER CONNECTION DEVICE

(71) Applicant: Hilti Aktiengesellschaft, Schaan (LI)

(72) Inventor: Hans RUPPRECHT, Muenchen (DE)

(21) Appl. No.: 16/346,520

(22) PCT Filed: Nov. 2, 2017
(86) PCT No.: PCT/EP2017/078019

§ 371 Date: Apr. 30, 2019

(30) Foreign Application Priority Data
Nov. 7, 2016 (EP) 16197487.8

(51) Int. Cl. F16L 37/086; F16L 37/22; B23Q 11/10

(52) U.S. Cl. CPC F16L 37/086; B23Q 11/10; F16L 37/22

(57) ABSTRACT

A water connection device including a release unit; a locking pin; a receptacle sleeve for accommodating the hose connector, and a recess for the locking pin; and a blocking ring including a first and second lateral surface, the locking pin being positionable in the recess, so that in a first position a hose connector is blocked and in a second position the hose connector is unblocked for removal, and the blocking ring being positionable so that in a first position the first lateral surface holds the locking pin in the first position and in a second position the locking pin is movable into the second position, and the release unit being movable from a first into a second position, so that in the second position the shoulder of the release unit presses against the blocking ring to move the blocking ring into the second position and thus makes the locking pin movable from the first into the second position.

The present invention relates to a water connection device, in particular for a water treatment device, for detachable connection to a hose connector.

### BACKGROUND

Water treatment devices represent a water recycling system in which water circulates in a closed circuit with a core drilling machine or a circular saw. However, according to an alternative operating mode of the water treatment device it is also possible that water does not circulate in a circuit with the power tools, but rather is only conveyed from the water treatment device to the power tools. When core drilling machines or circular saws are used for cutting a mineral material, for example, concrete or stone, it is necessary to cool and flush the tool, i.e., the drill bit or the saw blade. The flushing of the tool is used to wash off dust and slurry, which arises during the machining of the material, from the tool. The tool of a core drilling machine or a circular saw is typically cooled and flushed using water. The water is provided for this purpose in a water treatment device. Water is stored in a receptacle of the water treatment device. The receptacle may also be referred to as a water reservoir. With the aid of a water pump, which is located in a so-called suction head of the water treatment device and is typically positioned above the water reservoir, the water is conveyed via a water line (water hose) to the tools. The water runs in a circuit, in such a way that water is conveyed back to the water treatment device again in a second water line (water hose) after the tools (drill bit or saw blade) have been cooled and flushed. However, the water is soiled with dust and slurry, which forms during the machining of the material, by the cooling and flushing of the tool. So as not to damage the components and in particular the pump of the water treatment device with the dust or slurry, the soiled water has to be filtered. A filter unit is located in the water treatment device for this purpose. The filter unit is typically designed in the form of a filter bag, through which the water is filtered before it arrives back in the water reservoir and may again be conveyed by the pump of the suction head to the tools.

To connect the water line to the water treatment device in a detachable manner, a hose connector is provided on a free end of the water line and a water connection is provided on the water treatment device.

Both the connection of the water line to the water treatment device and the further detachment of the water line from the water treatment device may be complex and time-consuming in the case of the water connection devices on the market and/or in the case of the water connection devices according to the prior art.

### SUMMARY OF THE INVENTION

It is an object of the present invention to provide a water connection device, in particular for a water treatment device, for the detachable connection to a hose connector, using which both the connection of the water line to the water treatment device and the further detachment of the water line from the water treatment device is ensured in a simple manner.

The present invention provides a water connection device, in particular for a water treatment device, for detachable connection to a hose connector.

The following are provided according to the present invention for the water connection device
a release unit in the form of a sleeve having a pressure surface and a shoulder;
at least one locking pin for holding the hose connector in the water connection device;
a receptacle sleeve for accommodating the hose connector and having at least one (slotted) recess for accommodating the at least one locking pin; and
a blocking ring having a first and second lateral surface;
   the at least one locking pin being reversibly positionable in a first and second position in the recess, so that in the first position a hose connector located in the receptacle sleeve is blocked and in the second position the hose connector located in the receptacle sleeve is unblocked for removal from the receptacle sleeve, and the blocking ring being reversibly positionable in a first and second position, so that in the first position the first lateral surface of the blocking ring holds the at least one locking pin in the first position and in the second position the locking pin is movable into the second position, and the release unit being reversibly movable by pressure on the pressure surface from a first position into a second position, so that in the second position the shoulder of the release device presses against the first lateral surface of the blocking ring to move the blocking ring into the second position and thus make the at least one locking pin movable from the first position into the second position.

According to one advantageous specific embodiment of the present invention, it may be provided that the blocking ring includes a spring to hold the blocking ring in a spring-loaded manner in the first position. In this way, it is ensured that the blocking ring is held against the spring force of the spring in the first position. In addition, it is possible that the blocking ring may be moved with a certain application of force against the spring force of the spring from the first position into the second position.

According to another advantageous specific embodiment, it may be provided that at least one second locking pin is included. Still better holding of the hose connector in the water connection device is possible by way of a second locking pin.

Further advantages result from the following description of the figures. Various exemplary embodiments of the present invention are shown in the figures. The figures, the description, and the claims contain numerous features in combination. Those skilled in the art will advantageously also consider the features individually and combine them to form reasonable further combinations.

### BRIEF DESCRIPTION OF THE DRAWINGS

In the figures, identical and equivalent components are identified by identical reference numerals.

FIG. 1 shows a detail of a water treatment device having a water connection device according to the present invention for detachable connection to a hose connector;

FIG. 2 shows a sectional view of the water connection device according to the present invention;

FIG. 3 shows an exploded view of the water connection device according to the present invention;

FIG. 4 shows a side view of a hose connector for connection to the water connection device according to the present invention;

FIG. 5 shows a perspective rear view of a receptacle sleeve and release unit of the water connection device according to the present invention;

FIG. 6 shows a perspective rear view of the release unit of the water connection device according to the present invention;

FIG. 7 shows a side view of the receptacle sleeve and a blocking ring including a spring of the water connection device according to the present invention;

FIG. 8 shows a side view of the receptacle sleeve including locking pins of the water connection device according to the present invention;

FIG. 9 shows a side view of the receptacle sleeve, the blocking ring including a spring, and an adapter;

FIG. 10 shows a side view of the receptacle sleeve and the adapter;

FIG. 11 shows a side view of the receptacle sleeve, the adapter, the blocking ring including a spring, and the release unit as a sectional view;

FIG. 12 shows a lateral sectional view of the receptacle sleeve, the adapter, the blocking ring including a spring, and the release unit;

FIG. 13 shows a first perspective sectional view of the receptacle sleeve, the adapter, the blocking ring including a spring, and the release unit; and

FIG. 14 shows a second perspective sectional view of the receptacle sleeve, the adapter, the blocking ring including a spring, and the release unit.

### DETAILED DESCRIPTION

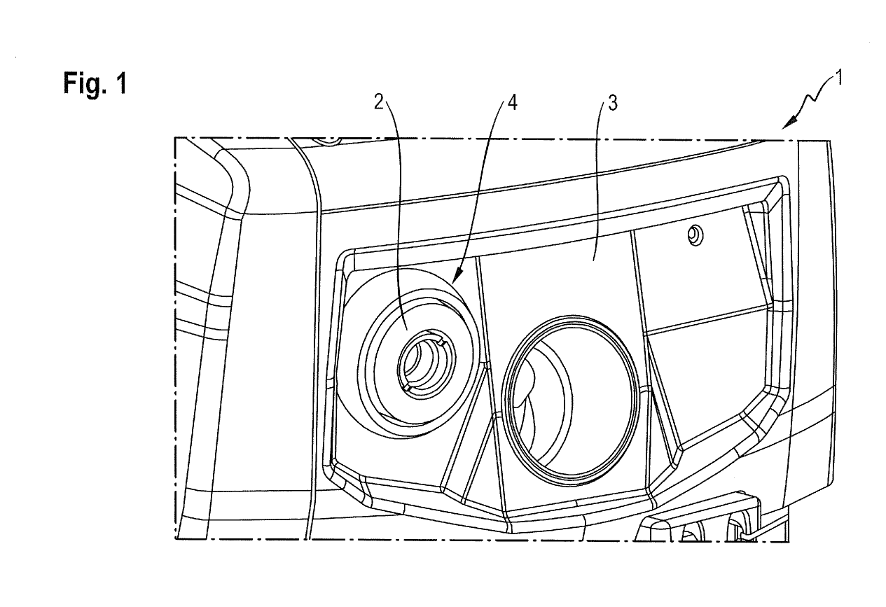

FIG. 1 shows a detail of a front part 2 of a water treatment device 1. Water treatment device 1 essentially includes a water reservoir and a suction head 3. Water treatment device 1 is essentially used to store water and provide it to a power tool. The power tool may be a core drilling machine or a circular saw. The power tool is not shown in the figures.

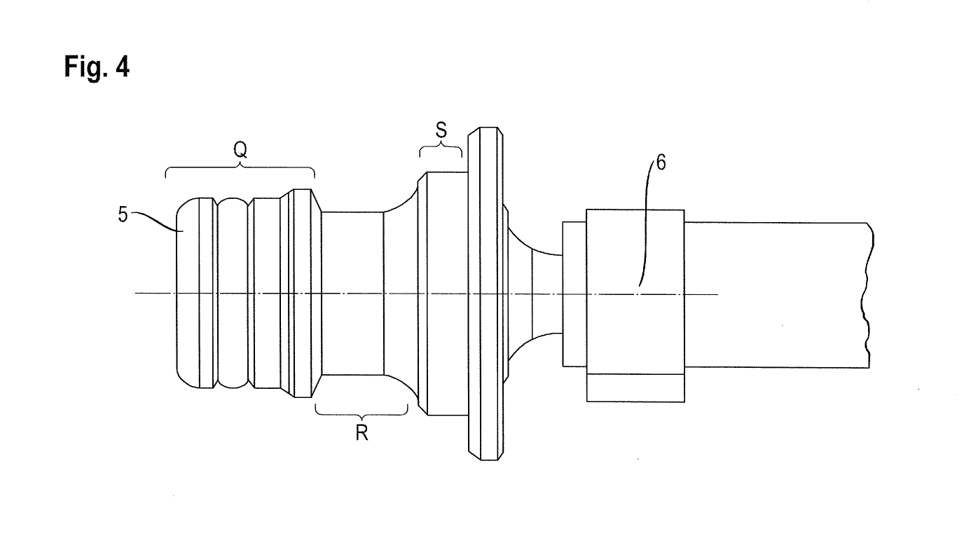

Water treatment device 1 furthermore includes a water connection device 4 for detachable connection to a hose connector 5. As shown in FIG. 4, hose connector 5 is a connecting piece at one end of a water hose 6. Hose connector 5 includes a first area Q having a first diameter, a second area R having a second diameter, and a third area S having a third diameter, the second diameter being smaller than the first diameter and third diameter. The second diameter may also be referred to as a waist. The first diameter is smaller than the third diameter.

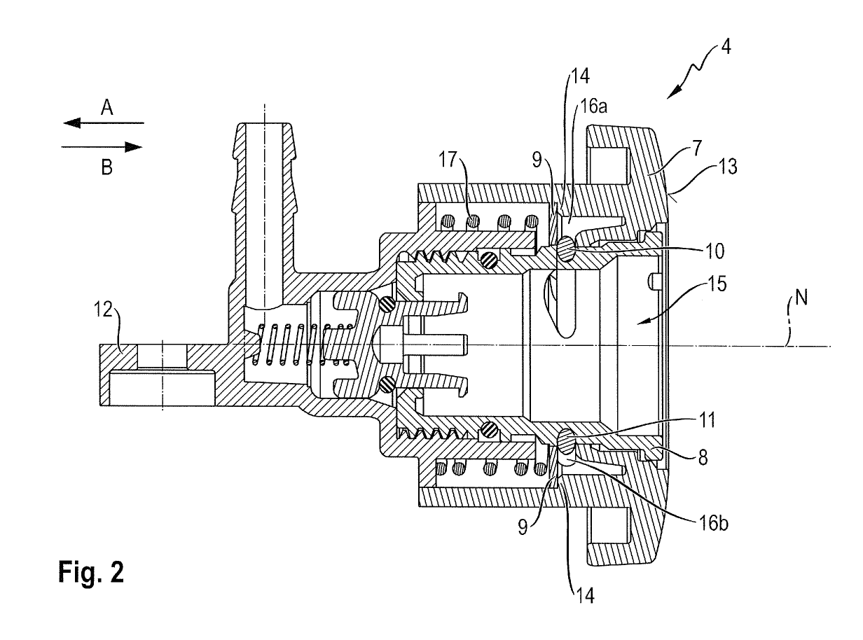

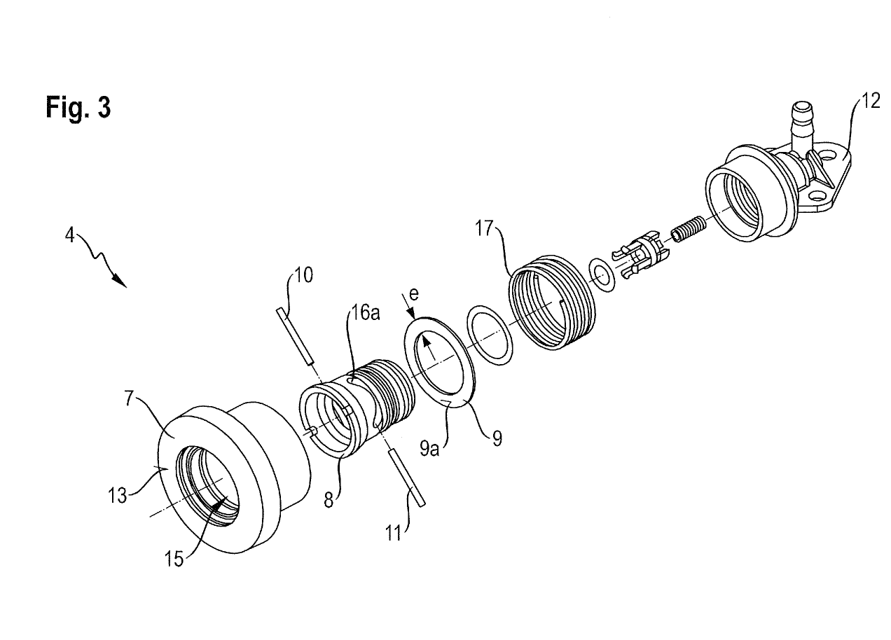

As shown in FIGS. 2 and 3, water connection device 4 essentially includes a release unit 7, a receptacle sleeve 8, a blocking ring 9, a first cylindrical locking pin 10, and a second cylindrical locking pin 11.

As described in detail hereafter, first and second locking pins 10, 11 are used for holding hose connector 5 in water connection device 4.

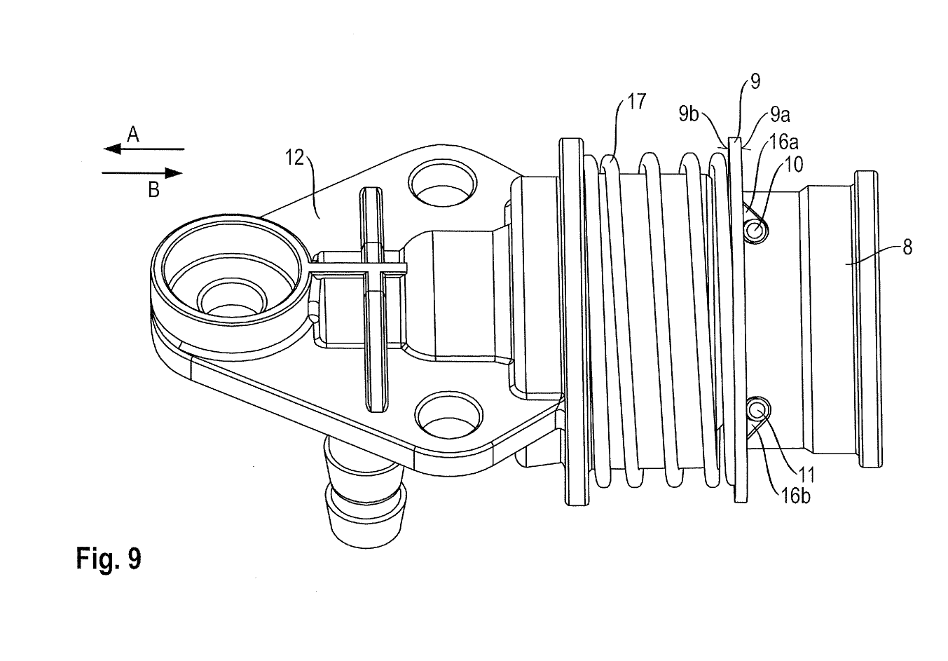

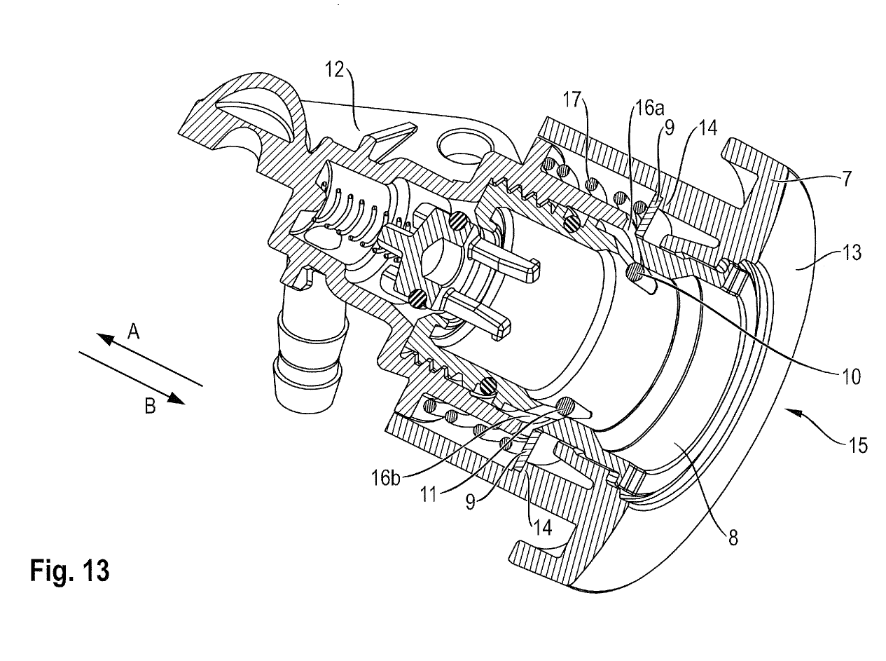

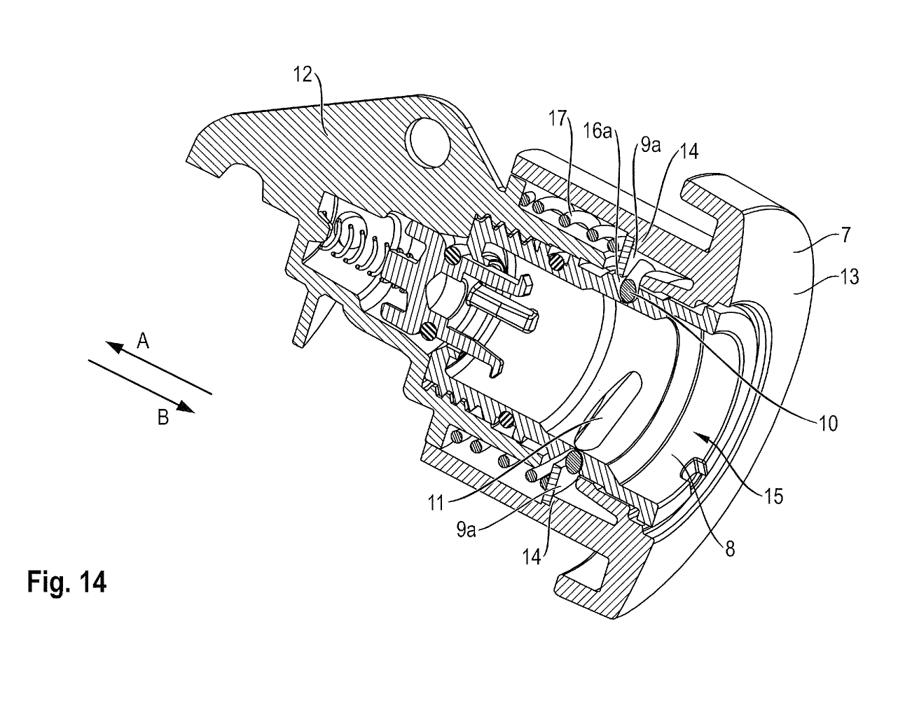

In the exemplary embodiment which is shown in FIGS. 2, 3, 5, 9, 10, 11, 12, 13, and 14, an adapter 12 is also provided, which will be described in detail hereafter. This adapter 12 is optional for water connection device 4.

Release unit 7 is designed in the form of a cylindrical sleeve and includes a ring-shaped pressure surface 13 and an internal shoulder 14. Release unit 7, which is designed as a sleeve, may be moved on water connection device 4 into a first and second position. In FIG. 2, release unit 7 is shown in the first position. To move release unit 7 into the second position, release unit 7 is moved in direction A. Release unit 7 moves in relation to receptacle sleeve 8 and adapter 12. To move release unit 7 from the first position into the second position, a certain pressure is exerted on pressure surface 13 in direction A. This pressure may be generated by the user. Shoulder 14 is formed as a projection and is located on an inner peripheral side of release unit 7. Shoulder or projection 14 may also be referred to as a crank.

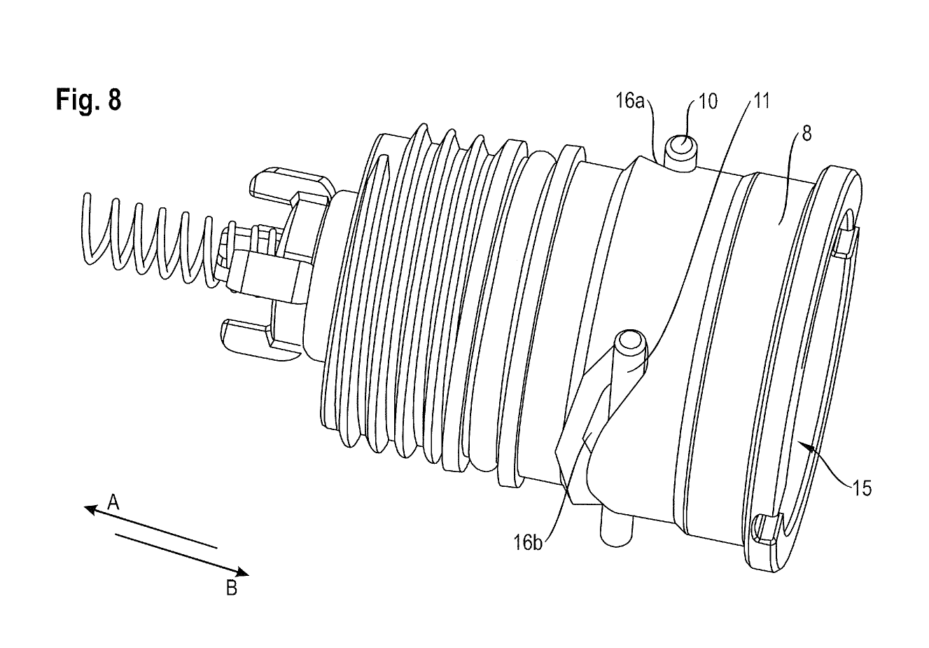

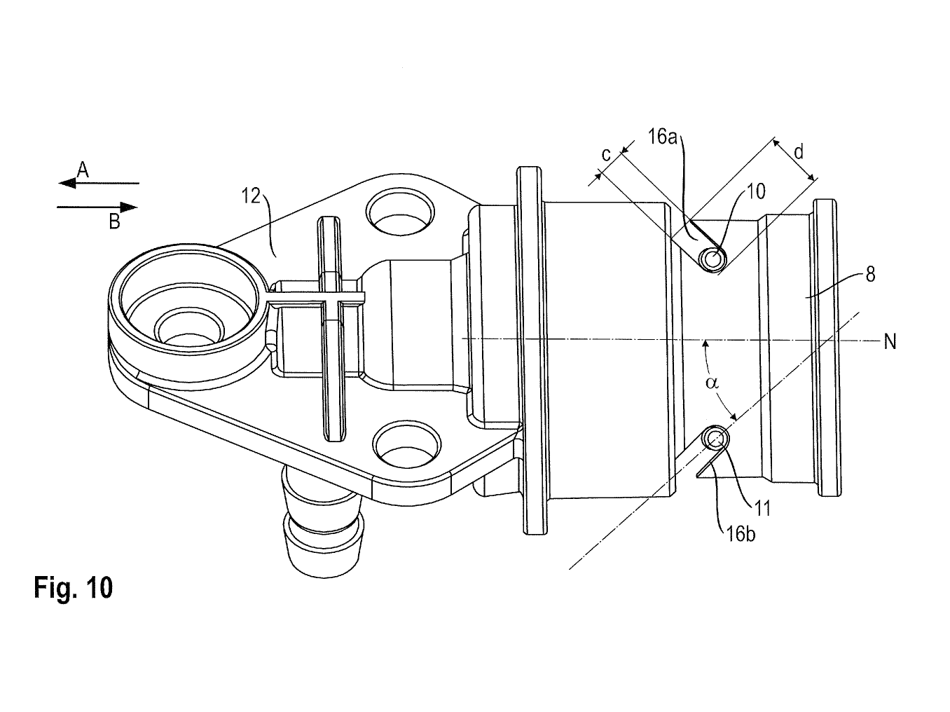

Receptacle sleeve 8 includes a stepped cylindrical cavity 15, in which hose connector 5 may be accommodated and held. The internal contour essentially corresponds to the external contour of hose connector 5 (cf. FIGS. 2 and 4). In addition, receptacle sleeve 8 includes a first and a second slotted recess 16a, 16b. Both first and second recess 16a, 16b extend at an acute angle α in relation to center axis N. First and second recesses 16a, 16b are opposite to one another on receptacle sleeve 8. Width c of each of first and second recesses 16a, 16b is somewhat wider than the diameter of first and second locking pin 10, 11, respectively, so that first locking pin 10 may be accommodated in first recess 16a and second locking pin 11 may be accommodated in second recess 16b. First and second recesses 16a, 16b have a depth d which approximately corresponds to two times the diameter of first or second locking pin 10, 11 or two times width c of first or second recess 16a, 16b (cf. FIG. 10). As shown in FIG. 8, first locking pin 10 is longer than first recess 16a and second locking pin 11 is longer than second recess 16b, so that a first and a second end of first locking pin 10 and a first and a second end of second locking pin 11 protrude out of respective recess 16a, 16b.

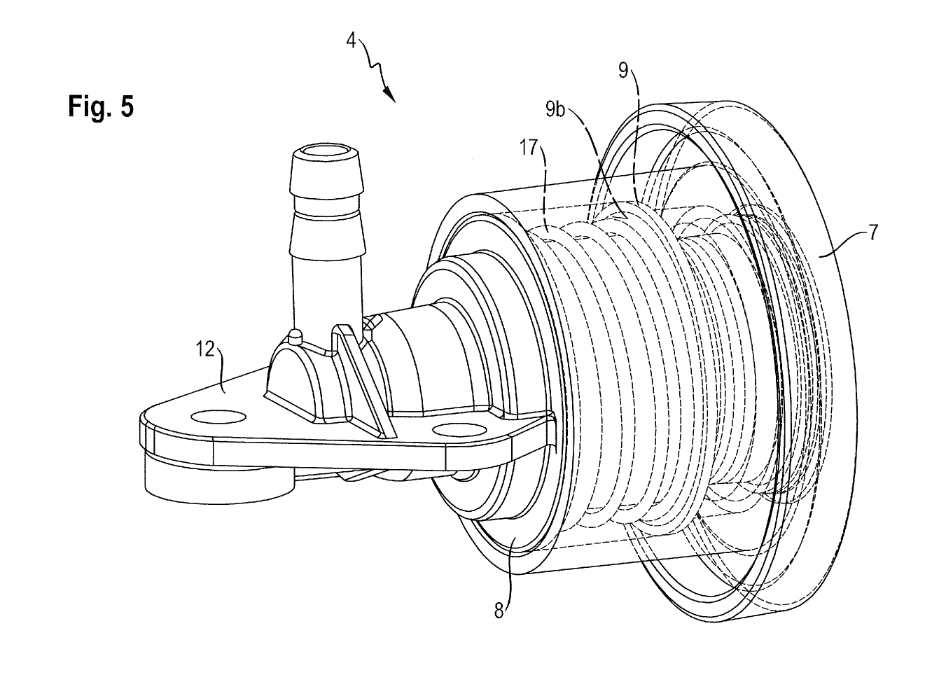

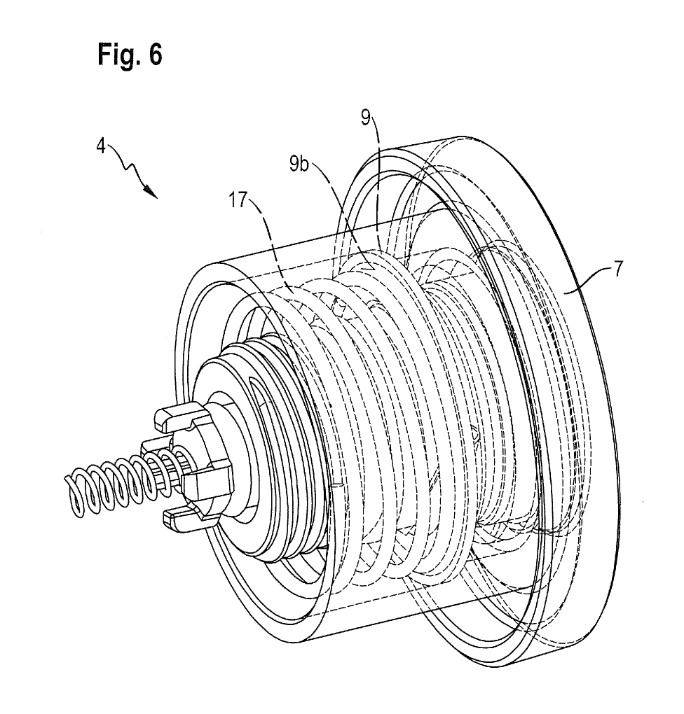

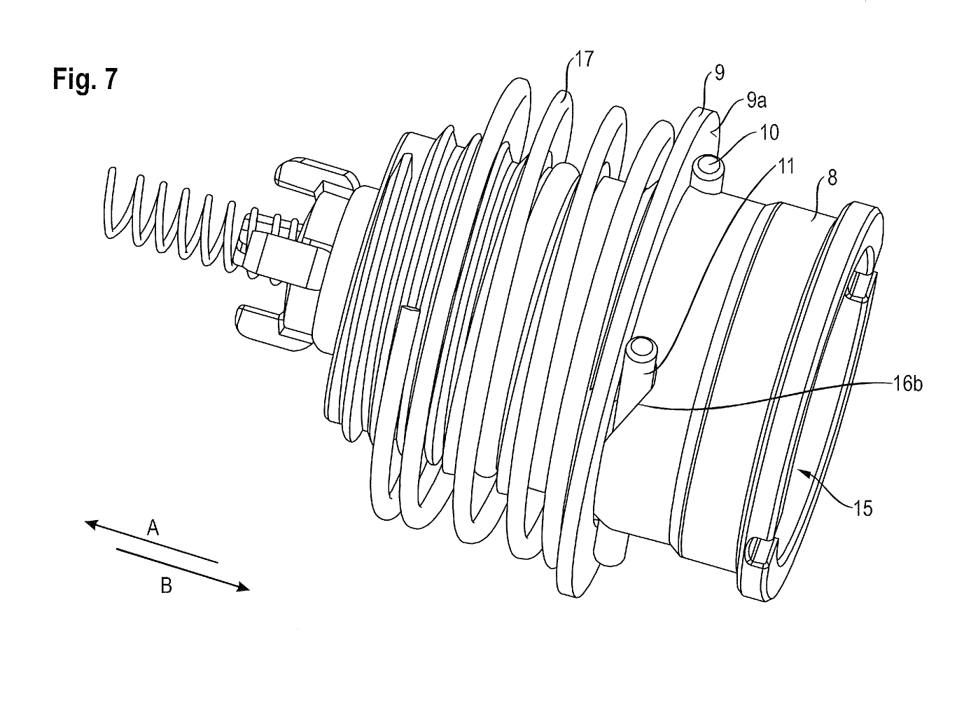

Blocking ring 9 is designed in the form of a disk-shaped ring and is positioned around receptacle sleeve 8. Blocking ring 9 includes a first and second lateral surface 9a, 9b. Ring width e of blocking ring 9 is greater than the first or second end of first or second locking pin 10, 11, which protrudes out of respective first or second recess 16a, 16b (cf. FIGS. 3 and 7). In this way, the ends of locking pins 10, 11 rest against first lateral surface 9a of blocking ring 9. A spring 17, which is positioned around receptacle sleeve 8, rests against second lateral surface 9b of blocking ring 9 (cf. FIGS. 5, 6, 7, 9, and 11). Spring 17 is designed in the form of a spiral spring. In an alternative specific embodiment, spring 17 may also be designed in the form of a leaf spring.

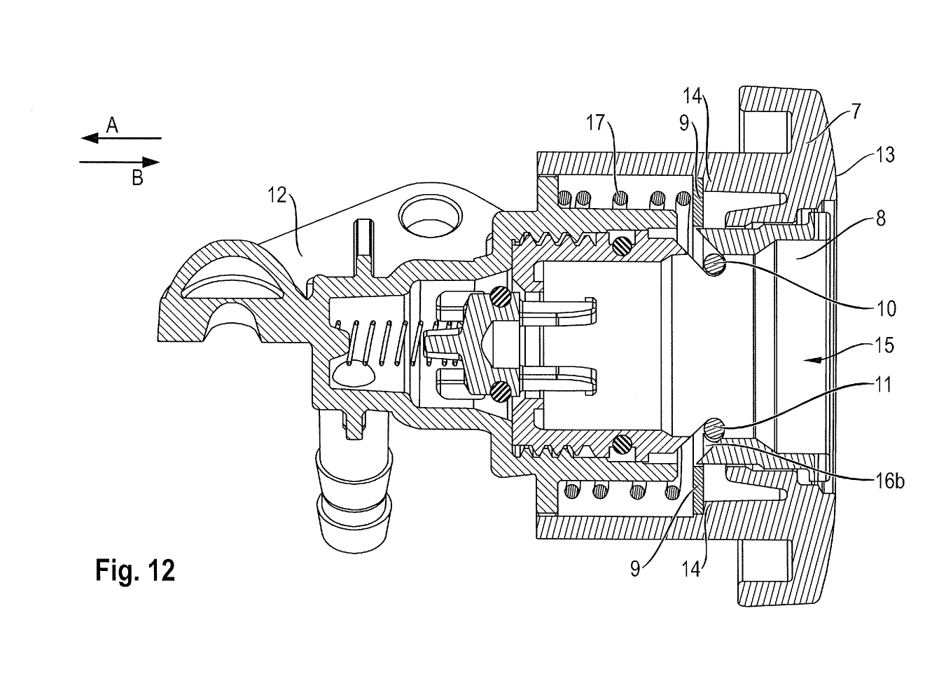

First and second locking pins 10, 11 are each reversibly positionable in a first and second position in first or second recess 16a, 16b, respectively. Locking pins 10, 11 move in relation to receptacle sleeve 8. When first or second locking pin 10, 11 is located in the first position, hose connector 5, which is inserted into receptacle sleeve 8, is blocked from a removal from receptacle sleeve 8. However, when first or second locking pin 10, 11 is located in the first position, hose connector 5 may be removed from receptacle sleeve 8 again. In FIGS. 7 through 11, first and second locking pins 10, 11 are each in the first position. In this case, first and second locking pins 10, 11 rest against the respective closed end of first and second slotted recess 16a, 16b. As is apparent in FIG. 12, the cross-sectional area of receptacle sleeve 8 is reduced when first and/or second locking pin 10, 11 is located in the second position. The cross-sectional area is reduced by the diameter or the cross-sectional area of first and second locking pins 10, 11.

Blocking ring 9 may be reversibly positioned in a first and second position. Blocking ring 9 moves in relation to receptacle sleeve 8. When blocking ring 9 is located in the first position, first and second locking pins 10, 11 are each pressed into the first position. The first lateral surface of blocking ring 9 presses on first and second locking pins 10, 11. It is apparent in FIGS. 2, 7, 9, and 11 that blocking ring 9 is located in the first position and acts on locking pins 10, 11. Spring 17, which is located behind blocking ring 9 in direction A, presses on second lateral surface 9b and presses with the spring force on blocking ring 9. To move blocking ring 9 from the first position into the second position, blocking ring 9 is moved or pressed against the spring force of spring 17 in direction A. When blocking ring 9 is located in the second position, pressure is no longer exerted by first lateral surface 9a of blocking ring 9 on locking pins 10, 11, so that locking pins 10, 11 are free to be moved from the first position into the second position.

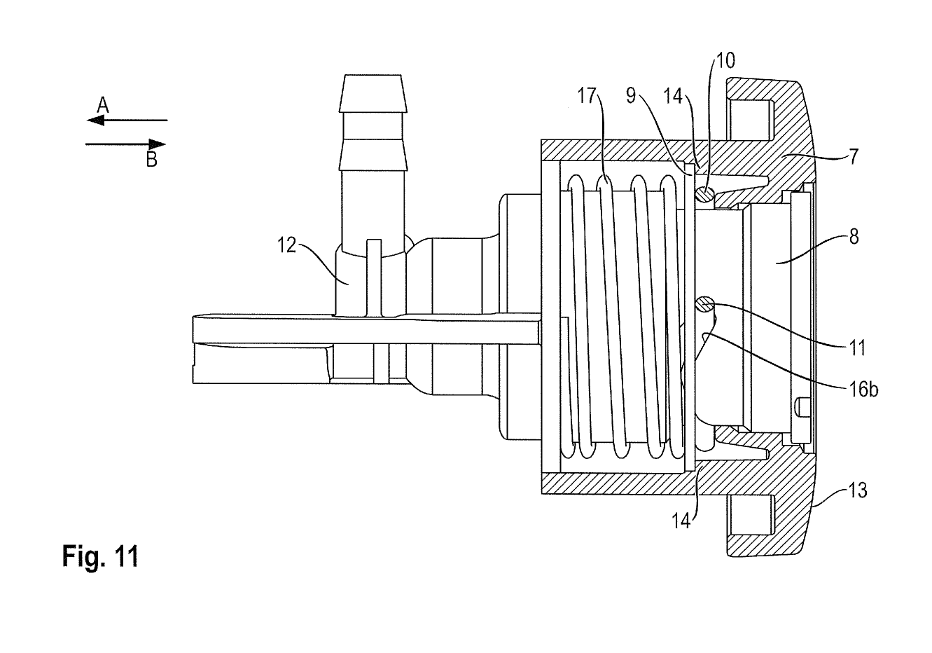

As already described above, release unit 7 may be reversibly moved from a first position into a second position. In FIGS. 11, 12, 13, and 14, release unit 7 is located in the first position. As is apparent in FIG. 11 in particular, a surface of shoulder 14 of release unit 7 rests against first lateral surface 9a of blocking ring 9. Ring width e of blocking ring 9 is sufficiently large that both the free ends of locking pins 10, 11, which are not located in slotted recesses 16a, 16b, and the surface of shoulder 14 of release unit 7 may rest against first lateral surface 9a of blocking ring 9 at the same time.

When release unit 7 is moved by a certain pressure in direction A on pressure surface 13 from the first position into the second position, the surface of shoulder 14 presses on first lateral surface 9a of blocking ring 9 and moves blocking ring 9 against the spring force of spring 17 from the first into the second position. As already described above, pressure is no longer exerted by first lateral surface 9a of blocking ring 9 on locking pins 10, 11 when blocking ring 9 moves from the first into the second position. Locking pins 10, 11 may now be moved from the first into the second position.

When pressure is no longer exerted on pressure surface 13 of release unit 7, the spring force of spring 17 causes blocking ring 9, locking pins 10, 11, and release unit 7 to be moved again in direction B from the second position back into the first position. In this way, the cross-sectional area of receptacle sleeve 8 is again reduced by the cross-sectional area of first and second locking pins 10, 11, so that a hose connector 5 located in receptacle sleeve 8 is blocked.

When a hose connector 5 of a water hose 6 is to be connected to water connection device 4 to supply or fill the water reservoir of a water treatment device 1, hose connector 5 is inserted into receptacle sleeve 8 of water connection device 1 in direction A. Release unit 7, blocking ring 9, and also the two locking pins 10, 11 are each located in the first position. Upon insertion into the interior of receptacle sleeve 8, first area Q of hose connector 5 presses first and second locking pins 10, 11 outward out of the first position. However, locking pins 10, 11 are not completely moved into the second position. When hose connector 5 is pushed further in direction A into receptacle sleeve 8 and is finally located in the end position, locking pins 10, 11 rest against second area R. When the two locking pins 10, 11 rest against second area R, the two locking pins 10, 11 are again located in the first position. Because slotted recesses 16a, 16b are located at an angle α in receptacle sleeve 8 (cf. FIG. 10) and blocking ring 9 presses with the aid of spring 17 on locking pins 10, 11, locking pins 10, 11 remain in the first position and block hose connector 5. Hose connector 5 thus may not be removed from receptacle sleeve 8 when release unit 7, blocking ring 9, and locking pins 10, 11 are each located in the first position.

To remove hose connector 5 from receptacle sleeve 8, release unit 7 is moved from the first into the second position (as described above). Shoulder 14 of release unit 7 presses against first lateral surface 9a of blocking ring 9 and thus moves blocking ring 9 from the first position into the second position. When blocking ring 9 is located in the second position, locking pins 10, 11 may be freely moved from the first position into the second position. When hose connector 5 is drawn in direction B out of receptacle sleeve 8, first area Q of hose connector 5 presses against freely movable locking pins 10, 11. The blockage by locking pins 10, 11 is now canceled out, so that hose connector 5 may be removed from receptacle sleeve 8.

Because release unit 7 may be moved with only one finger of the user of water treatment device 1 from the first into the second position, to finally make locking pins 10, 11 freely movable, a water connection device 4 is provided, using which both the connection of water hose 6 to water treatment device 1 and the further detachment of water hose 6 from water treatment device 1 are ensured in a simple manner.

What is claimed is:

1-3: (canceled)

4: A water connection device for detachable connection to a hose connector, the water connection device comprising:
a release unit in the form of a sleeve including a pressure surface and a shoulder;
at least one locking pin for holding the hose connector in the water connection device;
a receptacle sleeve for accommodating the hose connector and having at least one recess for accommodating the at least one locking pin; and
a blocking ring including a first and second lateral surface;
the at least one locking pin being reversibly positionable in a first and second position in the recess, so that in the first position a hose connector located in the receptacle sleeve is blocked and in the second position the hose connector located in the receptacle sleeve is unblocked for removal from the receptacle sleeve, and
the blocking ring being reversibly positionable in a first and second ring position, so that in the first ring position the first lateral surface of the blocking ring holds the at least one locking pin in the first position and in the second position, the locking pin being movable into the second position, and
the release unit being reversibly movable from a first release unit position into a second release unit position by pressure on the pressure surface, so that in the second release unit position, the shoulder of the release unit presses against the first lateral surface of the blocking ring to move the blocking ring into the ring second position and thus make the at least one locking pin movable from the first position into the second position.

5: The water connection device as recited in claim 4 wherein the blocking ring includes a spring to hold the blocking ring in a spring-loaded manner in the first ring position.

6: The water connection device as recited in claim 4 further comprising at least one second blocking pin.

7: A water treatment device comprising the water connection device as recited in claim 4.
